(19) United States
(12) Patent Application Publication
(10) Pub. No.: US 2016/0234215 A1
(43) Pub. Date: Aug. 11, 2016

(54) METHOD AND SYSTEM FOR MANAGING DATA ACCESS WITHIN AN ENTERPRISE

(71) Applicant: Google Inc., (US)

(72) Inventor: Umesh Shankar, New York, NY (US)

(73) Assignee: Google Inc., Mountain View, CA (US)

(21) Appl. No.: 13/780,425

(22) Filed: Feb. 28, 2013

Related U.S. Application Data
(60) Provisional application No. 61/604,801, filed on Feb. 29, 2012.

(51) Int. Cl. G06Q 10/08; H04L 29/06; G06Q 30/06

(52) U.S. Cl. CPC H04L 63/10

(57) ABSTRACT

A cloud computing service implements a method of securing customer data from access to only authorized administrative elements that are part of the cloud computing service. The service defines a set of access policies for the data, such that each access policy includes a permitted action. When the service receives a request to access the customer data, the request may include an access credential and originate from an administrative element within the cloud computing service. The service will verify the access credential and use the access credential to identify one of the access policies. The service will then identify a permitted action that is associated with the identified access policy and return a data access token to the administrative element. The data access token permits the administrative element to perform the identified permitted action on the customer data.

### CROSS REFERENCE TO RELATED APPLICATION

This application claims the priority benefit of U.S. Provisional Patent Application No. 61/604,801, filed on Feb. 29, 2012, which is incorporated by reference in its entirety.

### BACKGROUND

Hosted services, such as cloud-based data storage, mail, document management or similar services, store data on a server which is located at a facility that often is remote from the locations where the data may be generated or used. The remote servers are typically hosted by a third party, who allows the data's owner and authorized users to access the data over a communications network such as the Internet.

Customers of hosted services require that their data be stored in a secure manner. Therefore, it is desirable to manage data access not only from external requesters, but also from elements of the service itself, i.e., requesters that are part of the hosted service enterprise.

### SUMMARY

In an embodiment, a cloud computing service receives customer data for storage, generates an encryption key, uses the key to encrypt the data, stores the key in a key management system, and stores the encrypted customer data in a data storage facility. The service defines a plurality of access policies for the data, such that each access policy includes a permitted action. When the service then receives a request to access the customer data, the request may include an access credential and originate from an administrative element within the cloud computing service. The service will verify the access credential and use the access credential to identify one of the access policies. The service will then identify a permitted action that is associated with the identified access policy and return a data access token to the administrative element. The data access token permits the administrative element to perform the identified permitted action on the customer data. The service may record the administrative element, the request and the performed action in association with each other in a log file.

Optionally, when defining an access policy, the service may determine a constraint that includes a time limit or a maximum number of repeated actions. If so, the data access token may only permit the administrative element to perform the identified permitted action within the constraint. Each access policy may be associated with one or more resources within the cloud computing service. When verifying the data access credential, the service may verify that the access credential corresponds to the administrative element that is associated with the access policy. Access policies also may include an identifier for one or more users to whom access to the customer data has been delegated; an identifier that defines a maximum access scope for the token, what the token may be used to access, or both; and/or an identifier that defines a time period or expiration time.

Optionally, the administrative element also may provide an access reason. If so, the verifying may include confirming that the access reason conforms to at least one of the access policies.

Optionally, if the administrative element submits a subsequent request to access the customer data, and the subsequent request includes the data access credential, the service may verify that the constraint has not expired and, after such verification, permit the administrative element to access the customer data within the constraint without providing the administrative element a new data access credential for the request.

If the access request satisfied a notification rule of the identified access policy, the service may send a notification in accordance with the notification rule.

Any or all of the steps described above may be implemented by a processor that is part of or used with a cloud computing service that comprises a processor, a data storage facility, and a memory containing computer readable programming instructions that, when executed, cause the processor to implement the steps.

### BRIEF DESCRIPTION OF THE FIGURES

FIG. 1 depicts an example of various elements of a cloud computing service according to various embodiments.

FIG. 2 depicts an example process for managing access requests for data within a cloud computing service according to an embodiment.

FIG. 3 depicts example optional elements of a computing device that may be used with various embodiments of this disclosure.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For the purposes of this document, an “electronic device” refers to a device that includes a processor and tangible, computer-readable memory. The memory may contain programming instructions that, when executed by the processor, cause the device to perform one or more operations according to the programming instructions. Examples of electronic devices include personal computers, gaming systems, televisions, and portable electronic devices such as smartphones, personal digital assistants, cameras, tablet computers, laptop computers, media players and the like.

An “administrative element” means a person, service or software application of a cloud computing service that performs an action on a data resource.

A “client device” refers to an electronic device that is configured to access one or more administered resources over a network. A client device may be a portable or stationary electronic device. A “client application” refers to an application program configured to instruct a client device to perform one or more tasks.

A “cloud computing service” or a “hosted service” refers to one or more devices that store data at a facility that is remote from the location of a client device. The data may include application data, data files, programming instructions, and/or other data.

A “datastore” is a tangible, computer-readable memory device, or a group of such devices, within a cloud computing or hosted service.

A “data resource” is an electronic file containing information that a customer provides to a cloud computing service, such as a document file, an electronic mail message, a media file (e.g., photo or video), a social networking message, a user profile, or other data.

A “management server” refers to a computing device that is configured to apply an administrative policy to a client device. A management server device may include, without limitation, a server, a mainframe computer, a networked computer, a processor-based device, a virtual machine and/or the like.

A “wrapped key” refers to an encryption key that is itself encrypted (i.e., “wrapped”) using any suitable encryption technique, such as a hash of the user's password.

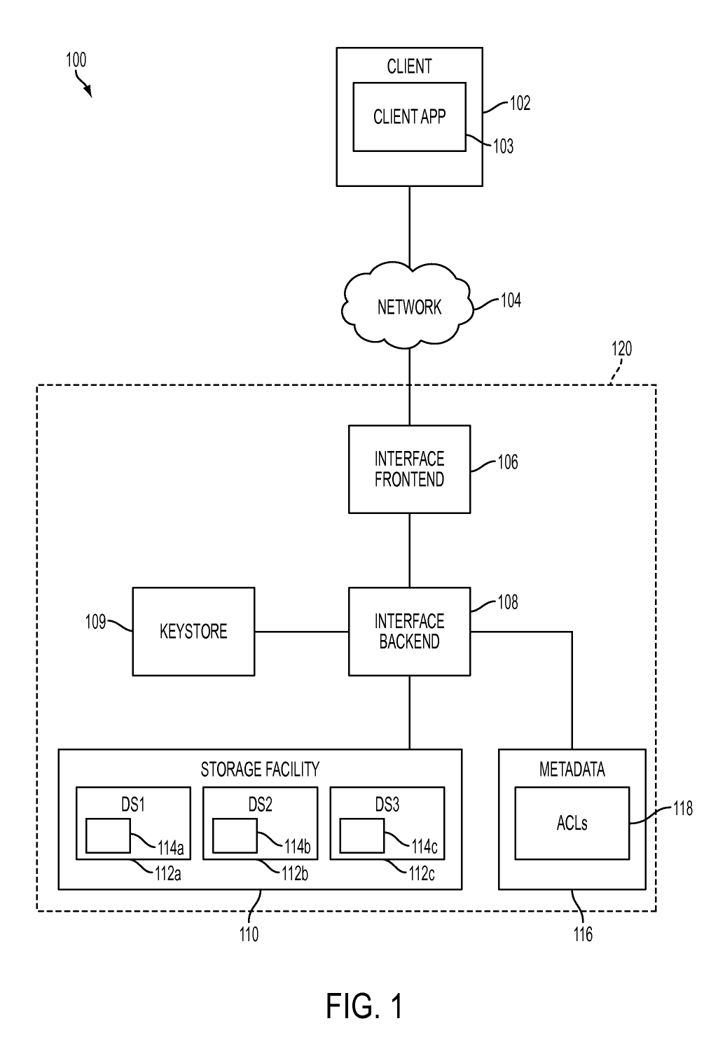

FIG. 1 illustrates a system 100 for transferring information between a client device 102 and a hosted service 120 according to an embodiment. In an embodiment, one or more client devices 102 may be connected to one or more communication networks 104. In an embodiment, client device 102 may include a tangible, computer-readable memory on which is stored a client application 103.

The communication network 104 may be connected to the hosted service 120. The hosted service 120 stores data in one or more storage facilities 110, which are data servers that include a tangible, computer-readable memory to store data. Any of the storage facilities 110 may be scalable by including two or more individual datastores 112a-112c. The datastores may serve as backups to each other, or they may be taken on or offline to create a larger or smaller overall storage facility depending on demand. In some embodiments, one or more of the datastores may be used to store data 114a-114c. Data 114a-114c may be of a particular format. For example, datastore 112a may store data 114a as Binary Large Object (BLOB) data, datastore 112b may store data 114b in a distributed file system (e.g, Network File System), and datastore 112c may store data 114c in a structured data format such as a database. This example is merely illustrative, and datastores 112a-112c may store data in any suitable format.

In various embodiments, the communication network 104 may be a local area network (LAN), a wide area network (WAN), a mobile or cellular communication network, an extranet, an intranet, the Internet and/or the like. In an embodiment, the communication network 104 may provide communication capability between the client device 102, an interface frontend device 106 and/or an interface backend device 108 of the hosted service 120. The client device 102 may communicate across the network 104 using any suitable communications protocol, such as Transmission Control Protocol/Internet Protocol (TCP/IP), Hypertext Transfer Protocol (HTTP), Secure Shell Remote Protocol (SSH), Application Program Interfaces (API), or any other suitable protocol. Although FIG. 1 only shows one client device 102, multiple client devices may communicate with the hosted service 120 across one or more networks 104.

In an embodiment, the hosted storage service may include an interface frontend device 106 which operates as a management server to receive requests from and send responses to the client device 102. The interface frontend device 106 may include a processor in communication with a computer-readable storage medium. The interface frontend device 106 may be in communication with one or more client devices 102 and/or the interface backend device 108. The interface frontend device 106, although depicted as a single computer system, may be implemented as a multiple devices. The interface frontend device 106 may receive messages (e.g., requests) from the client device 102 and parse the request into a format that can be used by the hosted service 120, such as a remote procedure call (RPC) to a management server such as the interface frontend device 106. The interface frontend device 106 may prepare responses generated by the hosted storage service 120 for transmission to the client 102.

In some embodiments, the interface frontend device 106 may include programing instructions configured to manage uploads and downloads of large files. This may include functionality such as pausing, resuming, and recovering an upload from time-out. The interface frontend device 106 may monitor load information and update logs, for example to track and protect against denial of service (DOS) attacks.

Some or all of the data resources stored in each storage facility 110 may be stored in encrypted format or unencrypted format. Data resources that are stored in encrypted format may be associated with one or more encryption keys that are stored in and/or provided by a keystore facility 109, which is a tangible memory that manages the issuance of encryption keys. Any or all of the stored data resources also may be associated with metadata 116 that is stored on a tangible, computer-readable memory. Example types of, and uses for, metadata will be described below.

The interface backend device 108 may include a processor in communication with a computer-readable storage medium. The interface backend device 108 may be in communication with one or more client devices 102 and/or the interface frontend device 106. The interface backend device 108, although depicted as a single computer system, may be implemented as multiple devices. The interface backend device 108 may operate as an authentication server to handle authentication of client requests, manage data resources and metadata, and key retrieval and distribution. In some embodiments, data management may be primarily or fully performed by the interface backend device 108, while external communications may be primarily or fully performed by the interface frontend device 106. Thus, in such embodiments, the interface backend device 108 may isolate the data resources from the client/facing interface frontend device 106 until authentication is performed.

The interface backend device 108 manages metadata 116 associated with the data resources that are in the storage facility 110. For example, a client may request access to a data resource using a data identifier, and the metadata may map the identifier to one or more of the datastores 112a-112c that store the resource. The metadata also may include information such as resource creation times, information about one or more groups or categories to which the resource belongs, resource size, hashes, and access control lists (ACLs) 118 for the resources and groups, or other suitable information. The interface backend device 108 may log activity for each resource, such as information about who accessed each resource and times of access.

The ACLs 118 may identify which users are authorized to perform actions on data resources or groups of data resources, and/or what actions may be performed on each resource or group. As used in this document, a user may be an individual or another identifier such as an invite token or an application identifier. In some embodiments, the ACLs 118 may include an ordered list of ACL entries.

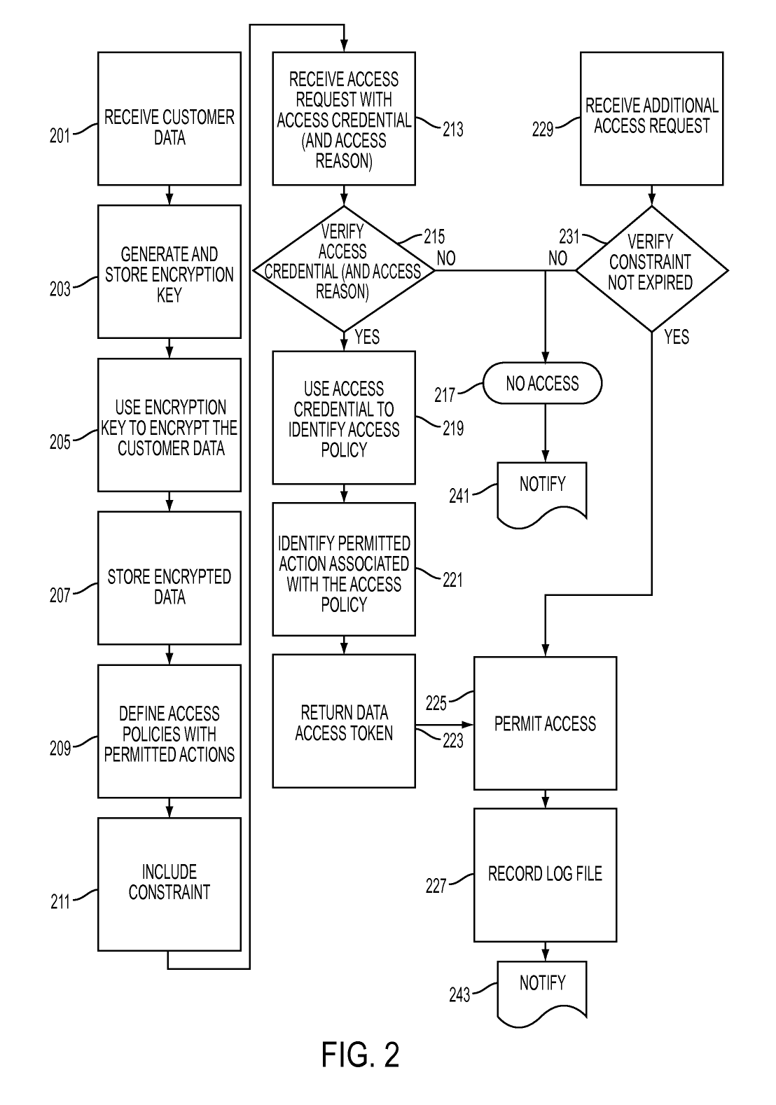

FIG. 2 illustrates steps that may be followed to control multi-user access to data that is uploaded to a datastore of a cloud computing service. When the service receives data from a customer 201, it may generate an encryption key and store the encryption key in a key management system 203, such as the keystore 109 described above in reference to FIG. 1. Referring again to FIG. 2, a processor in the service may then use the encryption key to encrypt the customer data 205 and store 207 the encrypted customer data in a data storage facility, such as a datastore of the storage facility 110 of FIG. 1. Alternatively, the customer data may be stored in unencrypted form in step 207, in which case steps 203 and 205 of FIG. 2 may not be performed by the cloud computing service.

The cloud computing service will define a set of access policies for the customer data 209. Each access policy will include one or more permitted actions. Optionally, the access policy or related information may be defined to include a constraint 211, such as a time limit (e.g., a period of time, or a fixed day and/or time of expiration) or a maximum number of repeated actions that are permitted on the data.

When the data is stored, optionally encrypted, and assigned access policies, the system may then manage requests to access the data. In particular, the service may receive access requests 213. Access requests may originate from administrative elements within the cloud computing service. Such a request may come from, for example, an administrative element that provides users with multiple applications, an administrator that access the data for a reason other than a user request (e.g., a mail service performing an internally-prompted review of mail service data), a first application (e.g., a mail service) requesting access to data that was uploaded by a second application (e.g., a social networking service), a human administrator who is performing system maintenance or debugging, or any other administrative elements within the service. To ensure that the request is valid, and to determine what the requestor is permitted to do with the data, the service will verify the requestor's access credential 215. Optionally, the service may require the requestor to provide a reason for the access, such as an intended use of the data.

The service will then use the access credential, and optionally the access reason, to identify an access policy 219 that is satisfied by the access credential. Each access policy is associated with one or more administrative elements within the cloud computing service. When verifying the access credential, the cloud computing service verifies that the access credential corresponds to the administrative element that is associated with the access policy. If no access policy satisfies the credential, the access request may be denied 217. If the access policy so indicates, the system may send a notification message 241 to a manager, group, service or others indicating that an access request has been denied.

However, if an access policy is identified 219, the system may permit the requestor to take one of various actions on the data 221. For example, the system may return a data access token to the requestor 223. The data access token is for the data that is associated with the identified access policy, and it may permit 225 the requestor to access and retrieve the data and its key and decrypt the customer data. Optionally, the system also may require verification that the access reason conforms to at least one of the access policies before it will permit access to the data. Optionally, if the access policy includes a permitted action, the system may identify the action 221, and the data access token will permit only such access as is defined by the permitted action. If the access policy or related information includes a constraint, the data access token may only permit the administrative element to perform the identified permitted action within the constraint. When complete, the service may record information about the administrative element (i.e., the requesting application or other user), the request and the performed action in association with each other in a log file 227. If the access policy so indicates, the system may send a notification message 243 to a manager, group, service or others indicating that access has been granted.

Optionally, if the service later receives a subsequent request from the administrative element to access the customer data 229, the system may determine whether the access policy's constraint has expired 231. If the constraint has expired, the service may deny the access request 217. If the constraint has not expired, then it may permit the administrative element to access the customer data 225 within the constraint without providing the administrative element a new data access credential for the request.

In the embodiments described above, an access policy may be a data or rule file that includes a name, as well as parameters that control a number of attributes, such as who (i.e., which users are authorized to access the data resource), what (i.e., the amount or scope of the data resource to which the user is authorized access), when (i.e., any conditions or constraints under which access is granted and/or how long the token will be valid), and notification (i.e., an optional identifier of who should be notified when a token request is granted or received).

For example, the “who” attribute may be implemented by a code string that defines a list of principals (e.g., users, groups or roles) that are authorized to initiate token requests. Another code string may define which principals are permitted to send token requests. Such a code string may require that tokens only be requested through defined services and may serve as an additional level of security to limit access to authorized users from the defined services. The “who” attribute may also define a list of delegates that are permitted to access a token because an authorized user has granted the access to the delegate. This would allow, for example, one user who is part of a group to grant access to all other members of the group without requiring everyone in the group to directly request access.

The “what” attribute may be implemented by a code string that defines a maximum access scope for the token, or what the token may be used to access. Optionally, these attributes may vary by user, such that only certain users can access the entire customer data set, while a broader number of users are permitted to access a limited portion of the data set.

The “when” attribute may be implemented by a code string that specifies a number of seconds, minutes, or other measure of time during which the token will remain valid. Alternatively, the “when” attribute may specify an expiration time for the token, after which the token is no longer valid.

The “notification” attribute may be implemented by a code string that defines a list of one or more notifications that will be sent when a specific action occurs. The specified action may be the grant of an access request, the denial of an access request, or other features such as repeated denial of an access request a threshold number of times. The notification may be an e-mail, text message, or other message sent to one or more specified administrators, team members, or others.

Optionally, the access policy also may include one or more usage attributes that indicate the use for which the customer data is intended. If so, the user may be required to include an access reason in its access request, and the system will only grant access if the access reason corresponds to one or more of the usage attributes.

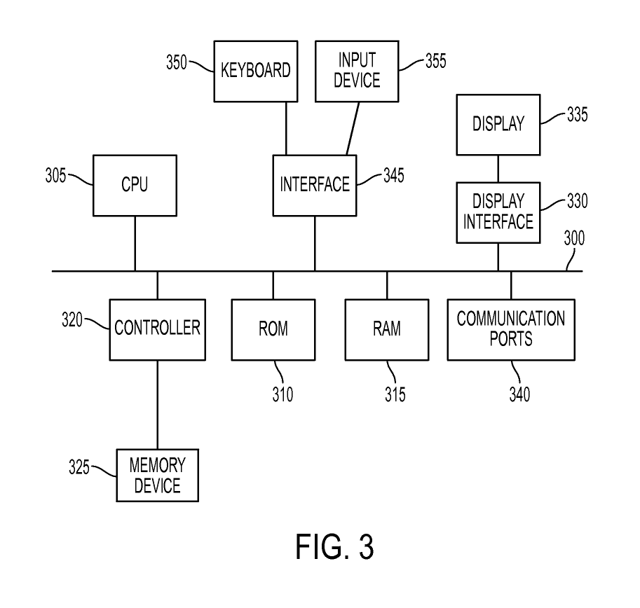

FIG. 3 is a block diagram of hardware that may be used to contain or implement program instructions according to an embodiment. A bus 300 serves as the main information pathway interconnecting the other illustrated components of the hardware. CPU 305 is the central processing unit of the system, performing calculations and logic operations required to execute a program. Read only memory (ROM) 310 and random access memory (RAM) 315 constitute exemplary memory devices.

A controller 320 interfaces one or more optional memory devices 325 to the system bus 300. These memory devices 325 may include, for example, an external or internal DVD drive, a CD ROM drive, a hard drive, flash memory, a USB drive or the like. As indicated previously, these various drives and controllers are optional devices.

Program instructions may be stored in the ROM 310 and/or the RAM 315. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 330 may permit information from the bus 300 to be displayed on the display 335 in audio, visual, graphic or alphanumeric format. Communication with external devices may occur using various communication ports 340. A communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method, comprising:
by a cloud computing service, receiving customer data for storage, storing the customer data in a data storage facility, and defining a plurality of access policies for the customer data, wherein each access policy includes:
a permitted action,
an indication of one or more users who are authorized to access the customer data,
an indication of an amount of time for which any token that is granted for the customer data will be valid, and
an identifier associated with who will be notified when access to the customer data is requested,
by a processor, receiving, from an administrative element within the cloud computing service, a request to access the customer data, wherein the request includes a data access credential and an access reason indicating an intended use of the customer data by the administrative element, wherein the administration element comprises a mail service, wherein the customer data comprises data that was provided by a social network service;
by the processor, verifying the data access credential and using the data access credential to identify one of the access policies;
by the processor, confirming that the access reason conforms to the identified access policy;
by the processor, identifying the permitted action that is associated with the identified access policy;
returning a data access token to the administrative element, wherein the data access token permits the administrative element to perform the identified permitted action on the customer data for the amount of time specified in the access policy;
recording the administrative element, the request and the performed action in association with each other in a log file;
receiving, from an administrative element, a subsequent request to access the customer data, wherein the subsequent request includes the data access credential;
determining that a constraint associated with the customer data has not expired, wherein the constraint defines a maximum number of repeated actions, wherein the constraint expires once the maximum number of repeated actions are performed on the customer data; and
upon determining that the constraint has not expired, permitting the administrative element to access the customer data within the constraint without providing the administrative element a new data access token for the request.

2. (canceled)

3. (canceled)

4. (canceled)

5. The method of claim 1, wherein:
each access policy is associated with one or more of a plurality of administrative elements within the cloud computing service; and
verifying the access credential comprises verifying, by the processor, that the data access credential corresponds to the administrative element that is associated with the access policy.

6. (canceled)

7. The method of claim 1, wherein the identified access policy comprises:
an identifier for one or more users to whom access to the customer data has been delegated;
an identifier that defines one or more of the following:
a maximum access scope for the token, and
what the token is used to access; and
an identifier that defines a time period or expiration time.

8. The method of claim 1, further comprising:
determining that the access request satisfies a notification rule of the identified access policy; and
sending a notification in accordance with the notification rule.

9. A method, comprising:
by a cloud computing service, receiving customer data for storage, storing the customer data in a data storage facility, and defining a plurality of access policies for the customer data, wherein each access policy comprises a permitted action and a constraint associated with the customer data, wherein the constraint defines a maximum number of repeated actions, wherein the constraint expires once the maximum number of repeated actions are performed on the customer data;
by a processor, receiving, from an administrative element within the cloud computing service, a request to access the customer data, wherein the request includes a data access credential and an access reason indicating an intended use of the customer data by the administrative element;
by the processor, verifying the data access credential and using the data access credential to identify one of the access policies;
by the processor, confirming that the access reason conforms to the identified access policy;
by the processor, verifying that the constraint associated with the identified access policy has not expired;
by the processor, identifying the permitted action that is associated with the identified access policy;
returning a data access token, wherein the data access token permits the administrative element to perform the identified permitted action on the customer data;
receiving, from an administrative element, a subsequent request to access the customer data, wherein the subsequent request includes a data access credential;
determining that the constraint has not expired; and
upon determining that the constraint has not expired, permitting the administrative element to access the customer data within the constraint without providing the administrative element with a new data access credential for the request.

10. The method of claim 9, further comprising:
determining that the access request satisfies a notification rule of the identified access policy; and
sending a notification in accordance with the notification rule.

11. The method of claim 9, wherein:
the identified access policy comprises:
an identifier for one or more users to whom access to the customer data has been delegated, and
one or more of the following:
an identifier that defines a maximum access scope for the token,
what the token is used to access, and
the constraint comprises an identifier that defines a time period or expiration time.

12. (canceled)

13. (canceled)

14. The method of claim 9, wherein:
each access policy is associated with one or more of a plurality of administrative elements within the cloud computing service; and
when verifying the access credential, the processor verifies that the data access credential corresponds to the administrative element that is associated with the access policy.

15. The method of claim 14, wherein the plurality of administrative elements comprise an electronic mail service and a social networking service.

16. A system, comprising:
a data storage facility;
one or more processors; and
one or more memory devices in communication with the processor, wherein the one or more memory devices comprise one or more computer readable programming instructions that, when executed, cause one or more of the processors to:
receive customer data from an external source,
store the customer data in the data storage facility,
define a plurality of access policies for the customer data, wherein each access policy includes:
a permitted action,
an indication of one or more users who are authorized to access the customer data,
an indication of an amount of time for which any token that is granted for the customer data will be valid, and
an identifier associated with who will be notified when access to the customer data is requested,
receive, from an administrative element within the cloud computing service, a request to access the customer data that is in the data storage facility, wherein the request includes a data access credential and an access reason indicating an intended use of the customer data by the administrative element, wherein the administration element comprises a mail service, wherein the customer data comprises data that was provided by a social network service,
verify the data access credential and use the data access credential to identify one of the access policies,
confirm that the access reason conforms to the identified access policy,
identify the permitted action that is associated with the identified access policy,
provide a data access token, wherein the data access token permits the administrative element to perform the identified permitted action on the customer data for the amount of time specified in the access policy,
receive, from an administrative element, a subsequent request to access the customer data, wherein the subsequent request includes a data access credential;
determine that a constraint associated with the customer data has not expired wherein the constraint defines a maximum number of repeated actions, wherein the constraint expires once the maximum number of repeated actions are performed on the customer data; and
permit, upon determining that the constraint has not expired, the administrative element to access the customer data within the constraint without providing the administrative element with a new data access credential for the request.

17. The system of claim 16, wherein the programming instructions, when executed, also cause one or more of the processors to:
determine that the access request satisfies a notification rule of the identified access policy; and
send a notification in accordance with the notification rule.

18. The system of claim 16, wherein:
the identified access policy further comprises:
an identifier for one or more users to whom access to the customer data has been delegated,
one or more of the following:
an identifier that defines a maximum access scope for the token, and
what the token is used to access, and
a constraint that comprises an identifier that defines a time period or expiration time; and
the programming instructions, when executed, cause one or more of the processors to verify that the constraint has not expired.

19. The system of claim 16, wherein:
the identified access policy comprises a usage attribute.

20.-23. (canceled)
